(19) United States
(12) Patent Application Publication
(10) Pub. No.: US 2006/0062298 A1
(43) Pub. Date: Mar. 23, 2006

(54) Method for encoding and decoding video signals

(76) Inventors: Seung Wook Park, Sungnam-si (KR); Ji Ho Park, Sungnam-si (KR); Byeong Moon Jeon, Sungnam-si (JP)

Correspondence Address: HARNESS, DICKEY & PIERCE, P.L.C., P.O. BOX 8910, RESTON, VA, 20195, US

(21) Appl. No.: 11/231,777

(22) Filed: Sep. 22, 2005

Related U.S. Application Data
(60) Provisional application No. 60/612,183, filed on Sep. 23, 2004.

(30) Foreign Application Priority Data
Feb. 22, 2005 (KR) 10-2005-0014380

(51) Int. Cl. H04N 7/12; H04N 11/04; H04B 1/66; H04N 11/02

(52) U.S. Cl. 375/240.12

(57) ABSTRACT

In one embodiment, at least one reference block from the encoded video signal is selectively filtered and at least one target block in the encoded video signal is decoded based on the selectively filtered reference block.

### DOMESTIC PRIORITY INFORMATION

This application claims priority under 35 U.S.C. §119 on U.S. provisional application 60/612,183, filed Sep. 23, 2004; the entire contents of which are hereby incorporated by reference.

### BACKGROUND OF THE INVENTION

1. Field of the Invention

The present invention relates to a method for encoding and decoding video signals.

2. Description of the Related Art

A number of standards have been suggested for digitizing video signals. One well-known standard is MPEG, which has been adopted for recording movie content, etc., on recording media such as DVDs and is now in widespread use. Another standard is H.264, which is expected to be used as a standard for high-quality TV broadcast signals in the future.

While TV broadcast signals require high bandwidth, it is difficult to allocate such high bandwidth for the type of wireless transmissions/receptions performed by mobile phones and notebook computers, for example. Thus, video compression standards for use with mobile devices must have high video signal compression efficiencies.

Such mobile devices have a variety of processing and presentation capabilities so that a variety of compressed video data forms must be prepared. This indicates that the same video source must be provided in a variety of forms corresponding to a variety of combinations of variables such as the number of frames transmitted per second, resolution, the number of bits per pixel, etc. This imposes a great burden on content providers.

In view of the above, content providers prepare high-bitrate compressed video data for each source video and perform, when receiving a request from a mobile device, a process of decoding compressed video and encoding it back into video data suited to the video processing capabilities of the mobile device before providing the requested video to the mobile device. However, this method entails a transcoding procedure including decoding and encoding processes, and causes some time delay in providing the requested data to the mobile device. The transcoding procedure also requires complex hardware and algorithms to cope with the wide variety of target encoding formats.

A Scalable Video Codec (SVC) has been developed in an attempt to overcome these problems. This scheme encodes video into a sequence of pictures with the highest image quality while ensuring that part of the encoded picture sequence (specifically, a partial sequence of frames intermittently selected from the total sequence of frames) can be used to represent the video with a low image quality.

Motion Compensated Temporal Filtering (MCTF) is an encoding scheme that has been suggested for use in the scalable video codec. However, the MCTF scheme requires a high compression efficiency (i.e., a high coding rate) for reducing the number of bits transmitted per second since it is highly likely that it will be applied to mobile communication where bandwidth is limited, as described above.

In the MCTF, which is a Motion Compensation (MC) encoding method, it is beneficial to find overlapping parts (i.e., temporally correlated parts) in a video sequence. As will be described in detail later, the MCTF includes prediction and update steps. In the prediction step, motion estimation (ME) and motion compensation (MC) operations are performed to reduce residual errors.

The ME/MC operations are performed based on a method of searching for highly correlated blocks in units of blocks in order to reduce the amount of computation. However, blocking artifacts may occur at the boundaries of the blocks. The blocking artifacts increase high frequency components in L and H frames, which are created during the prediction and update steps and will be described later. This results in a reduction of the coding efficiency. Blocking artifacts may also appear in decoded video in low bitrate enviromnents.

Some filtering techniques for reducing these blocking artifacts have been introduced. One example is a filtering method in which low-pass filtering is performed on the boundaries of blocks. However, such a filtering method does not necessarily improve MCTF encoding/decoding performance.

### SUMMARY OF THE INVENTION

The present invention relates to encoding and decoding a video signal by motion compensated temporal filtering (MCTF).

According to an embodiment of the method of decoding an encoded video signal by inverse motion compensated temporal filtering (MCTF), at least one reference block from the encoded video signal is selectively filtered and at least one target block in the encoded video signal is decoded based on the selectively filtered reference block.

In one embodiment, information indicating whether the reference block was filtered is obtained from the encoded video signal, and the reference block is selectively filtered based on the obtained information.

In one embodiment, the information indicating whether or not the reference block has been filtered is set in units of frame groups. In another embodiment, if each frame in a frame interval is divided into a plurality of slices, the information indicates whether or not the reference block has been filtered is set in units of slices in a group of frames.

In one embodiment of the method of encoding a video signal by motion compensated temporal filtering (MCTF), at least one reference block obtained from the video signal is selectively filtered and at least one target block in the video signal is encoded based on the selectively filtered reference block. For example, the reference block is not filtered if the target block represents a portion of an image having high resolution and low motion with respect to the image represented at least in part by the reference block.

In one embodiment, information is added to the encoded video signal indicating whether a reference block, used in encoding the encoded video signal, has been filtered.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of a video signal encoding device to which a scalable video signal compression method according to the present invention is applied;

FIG. 2 is a block diagram of a filter that performs video estimation/prediction and update operations in the MCTF encoder shown in FIG. 1;

FIG. 3 illustrates a general 5/3 tap MCTF encoding procedure;

FIG. 4 illustrates a estimator/predictor of the MCTF encoder modified according to an embodiment of the present invention.

FIG. 5 is a block diagram of a device for decoding a data stream according to an example embodiments of the present invention; and

FIG. 6 is a block diagram of an inverse filter that performs inverse estimation/prediction and update operations in the MCTF decoder shown in FIG. 5 according to an example embodiment of the present invention.

### DETAILED DESCRIPTION OF EXAMPLE EMBODIMENTS

Example embodiments of the present invention will now be described in detail with reference to the accompanying drawings.

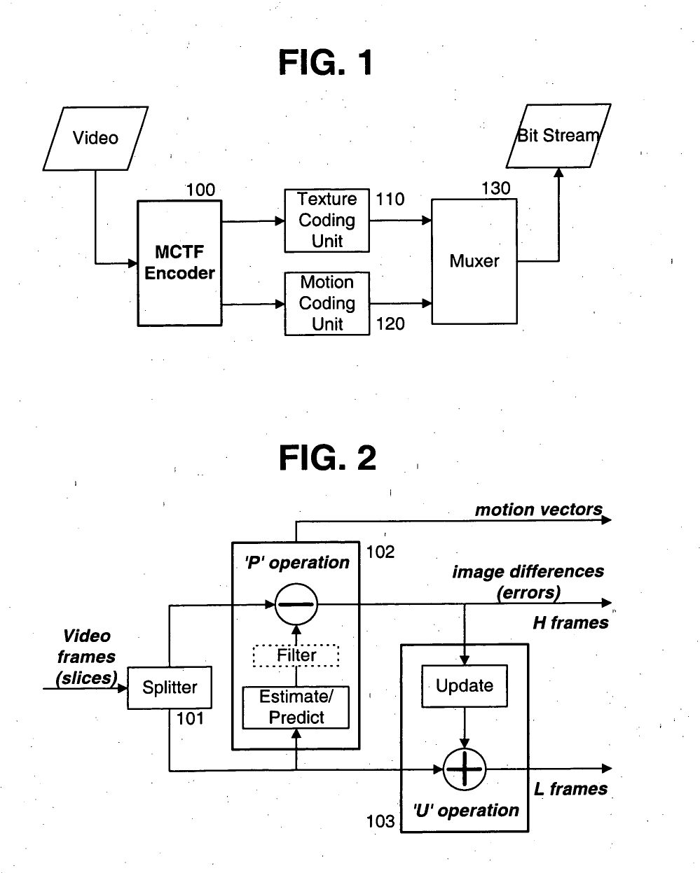

FIG. 1 is a block diagram of a video signal encoding device to which a scalable video signal compression method according to the present invention is applied.

The video signal encoding device shown in FIG. 1 comprises an MCTF encoder 100, a texture coding unit 110, a motion coding unit 120, and a muxer (or multiplexer) 130. The MCTF encoder 100 encodes an input video signal in units of macroblocks in an MCTF scheme, and generates suitable management information. The texture coding unit 110 converts data of encoded macroblocks into a compressed bitstream. The motion coding unit 120 codes motion vectors of image blocks obtained by the MCTF encoder 100 into a compressed bitstream according to a specified scheme. The muxer 130 encapsulates the output data of the texture coding unit 110 and the output vector data of the motion coding unit 120 into a set format. The muxer 130 multiplexes the encapsulated data into a set transmission format and outputs a data stream.

The MCTF encoder 100 performs motion estimation and prediction operations on each macroblock of a video frame, and also performs an update operation in such a manner that an image difference of the macroblock from a corresponding macroblock in a neighbor frame is added to the corresponding macroblock. FIG. 2 is a block diagram of a portion of the MCTF encoder 100 of FIG. 1 for carrying out these operations.

As shown in FIG. 2, the MCTF encoder 100 includes a splitter 101, an estimator/predictor 102, and an updater 103. The splitter 101 splits an input video frame sequence into earlier and later frames in pairs of successive frames (for example, into odd and even frames). The estimator/predictor 102 performs motion estimation and/or prediction operations on each macroblock in an arbitrary frame in the frame sequence. As described in more detail below, the estimator/predictor 102 searches for a reference block of each macroblock of the arbitrary frame in neighbor frames prior to and/or subsequent to the arbitrary frame and calculates an image difference (i.e., a pixel-to-pixel difference) of each macroblock from the reference block and a motion vector between each macroblock and the reference block. The updater 103 performs an update operation on a macroblock, whose reference block has been found, by normalizing the calculated image difference of the macroblock from the reference block and adding the normalized difference to the reference block. The operation carried out by the updater 103 is referred to as a ‘U’ operation, and a frame produced by the ‘U’ operation is referred to as an ‘L’ (low) frame.

The MCTF encoder 100 of FIG. 2 may perform its operations on a plurality of slices simultaneously and in parallel, which are produced by dividing a single frame, instead of performing its operations in units of frames. In the following description of the embodiments, the term ‘frame’ is used in a broad sense to include a ‘slice’.

The estimator/predictor 102 divides each of the input video frames into macroblocks of a set size. For each macroblock, the estimator/predictor 102 searches for a macroblock, whose image is most similar to the macroblock (referred to as the “target macroblock”), in neighbor frames prior to and/or subsequent to the input video frame through MC/ME operations. That is, the estimator/predictor 102 searches for a macroblock having the highest temporal correlation with the target macroblock. A block having the most similar image to a target image block has the smallest image difference from the target image block. The image difference of two image blocks is defined, for example, as the sum or average of pixel-to-pixel differences of the two image blocks. Accordingly, of macroblocks in a previous/next neighbor frame having a threshold pixel-to-pixel difference sum (or average) or less from a target macroblock in the current frame, a macroblock having the smallest difference sum (or average) from the target macroblock is referred to as a reference macroblock. For each macroblock of a current frame, two reference blocks may be present in two frames prior to or subsequent to the current frame, or in one frame prior and one frame subsequent to the current frame.

If the reference block is found, the estimator/predictor 102 calculates and outputs a motion vector from the current block to the reference block, filters the reference block to reduce blocking artifacts, and then calculates and outputs differences of pixel values of the current block from pixel values of the filtered reference block, which may be present in either the prior frame or the subsequent frame. Alternatively, the estimator/calculator 102 calculates and outputs differences of pixel values of the current block from average pixel values of two filtered reference blocks, which may be present in the prior and subsequent frames.

Such an operation of the estimator/predictor 102 is referred to as a ‘P’ operation. A frame having an image difference, which the estimator/predictor 102 produces via the P operation, is referred to as an ‘H’ (high) frame since this frame has high frequency components of the video signal.

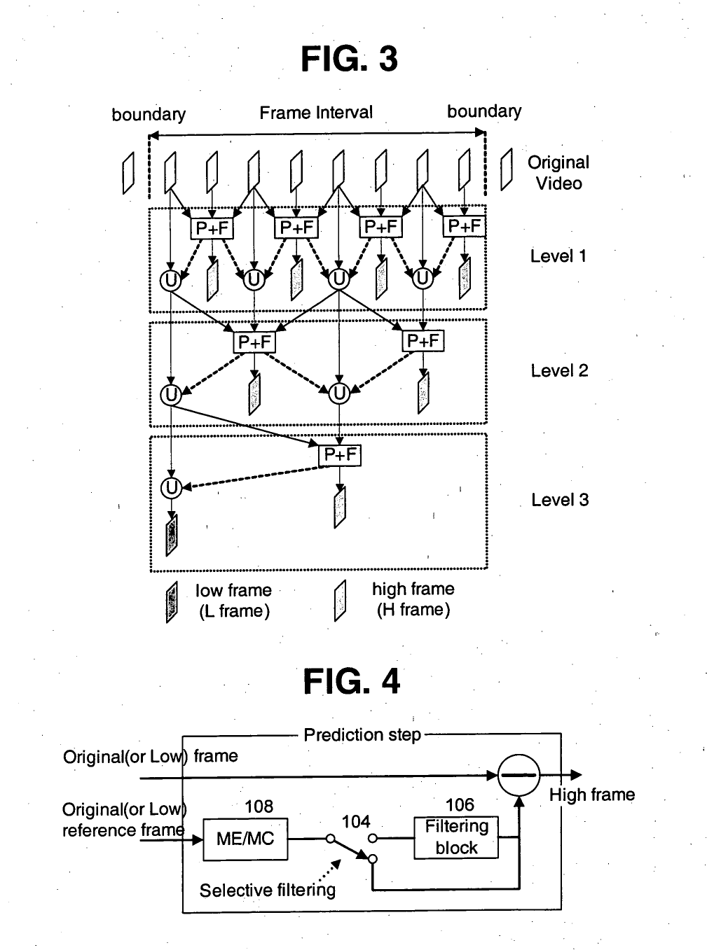

FIG. 3 illustrates a general 5/3 tap MCTF encoding procedure in which filtering is unconditionally performed on the reference block found by the MC/ME operations while the ‘P’ operation is performed. The general MCTF encoder performs the ‘P’ and ‘U’ operations described above over a plurality of levels in units of specific video frame intervals. Specifically, the general MCTF encoder generates H and L frames of the first level by performing the ‘P’ and ‘U’ operations on a plurality of frames in a current video frame interval, and then generates H and L frames of the second level by repeating the ‘P’ and ‘U’ operations on the generated L frames of the first level via an estimator/predictor and an updater at a next serially-connected level (i.e., the second level) (not shown).

Since all L frames generated at each level are used to generate L and H frames of a next level, only H frames remain at every level other than the last level, where L frame(s) and H frame(s) remain.

The ‘P’ and ‘U’ operations may be repeated up to a level such that one H frame and one L frame remains. The last level at which the ‘P’ and ‘U’ operations are performed is determined based on the total number of frames in the video frame interval. Optionally, the MCTF encoder may repeat the ‘P’ and ‘U’ operations up to a level at which two H frames and two L frames remain or up to its previous level.

In the example of FIG. 3, the MCTF encoder 100 performs the ‘P’ and ‘U’ operations over three levels since each video frame interval is composed of 8 (=2³) frames. At the first level, the MCTF encoder generates 4 L frames and 4 H frames from the 8 frames; at the second level, the MCTF encoder 100 generates 2 L frames and 2 H frames from the 4 L frames of the first level; and, at the last (i.e., 3rd) level, the MCTF encoder 100 generates one L frame and one H frame from the 2 L frames of the second level. Consequently, the MCTF encoder generates 4 H frames of the first level, 2 H frames of the second level, and one L frame and one H frame of the third level.

However, MCTF encoding/decoding performance is not necessarily improved even if reference blocks are filtered to remove blocking artifacts as described above. For a video sequence with low motion and high resolution images, encoding/decoding performance when no filtering is performed on reference blocks may be higher than when filtering is performed on reference blocks.

In an embodiment of the present invention, as shown in FIG. 4, the filtering operation for removing blocking artifacts is selectively performed on reference blocks when the ‘P’ operation is performed. To accomplish this, the MCTF encoder 100, and more particularly the estimator/predictor 102, may be modified such that a switch 104 is provided between a filtering block 106 and an ME/MC unit 108 of the estimator/predictor 102. The switch 104 performs a switching operation according to a control signal, which indicates whether to perform the filtering operation.

For example, the control signal may indicate to omit the filtering operation on reference macroblocks for a video sequence with low motion and high resolution images, and may indicate to perform the filtering operation for other video sequences, thereby improving encoding/decoding performance. Generation of the control signal may be based, for example, on the temporal correlation between the image including the target macroblock and the image including the reference macroblock. If the images are of high resolution and the temporal correlation exceeds a threshold level, the motion is low and the resolution high. In this situation, filtering is omitted; otherwise, filtering is performed.

If H and L frames are produced by performing the filtering operation on reference blocks in the MCTF encoding procedure, the same filtering operation must be performed when the generated H and L frames are subjected to an inverse prediction operation in the decoding procedure. Likewise, if the filtering operation is not performed on reference blocks in the MCTF encoding procedure, there is no need to perform the filtering operation in the inverse prediction operation in the decoding procedure.

Accordingly, the modified MCTF encoder 100 may inform the decoder of whether or not the filtering operation has been performed on reference blocks in the ‘P’ operation in the encoding procedure. The modified MCTF encoder 100 according to an embodiment of the present invention records a 1-bit information field (disable_filtering) at a specific position of a header area of a group of frames (hereinafter also referred to as a Group Of Picture (GOP)) generated by encoding a video frame interval. Namely, the MCTF encoder adds the information to the encoded video signal. The ‘disable_filtering’ information field indicates whether or not the filtering operation has been performed on reference blocks in the GOP.

The MCTF encoder 100 according to the present invention deactivates the ‘disable_filtering’ information if filtering has been performed on reference blocks in the ‘P’ operation. Otherwise, the MCTF encoder 100 activates the ‘disable_filtering’ information.

If a frame is divided into a plurality of slices and MCTF encoding is individually performed for each slice, the ‘disable_filtering’ information field may be recorded (e.g., added) in a header area of a corresponding slice layer in the GOP.

The data stream encoded in the method described above is transmitted by wire or wirelessly to a decoding device or is delivered via recording media. The decoding device restores the original video signal of the encoded data stream according to the method described below.

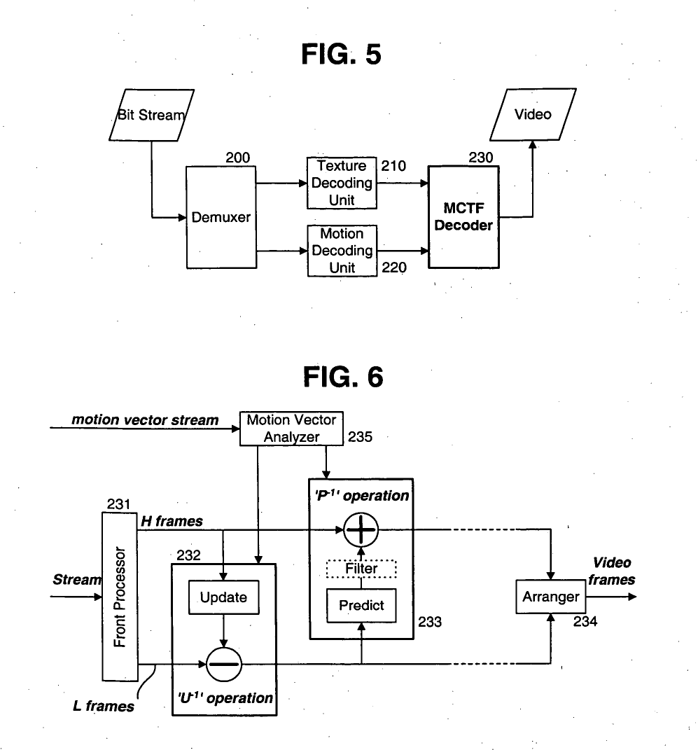

FIG. 5 is a block diagram of a device for decoding a data stream encoded by the device of FIG. 1. The decoding device of FIG. 5 includes a demuxer (or demultiplexer) 200, a texture decoding unit 210, a motion decoding unit 220, and an MCTF decoder 230. The demuxer 200 separates a received data stream into a compressed motion vector stream and a compressed macroblock information stream. The texture decoding unit 210 restores the compressed macroblock information stream to its original uncompressed state. The motion decoding unit 220 restores the compressed motion vector stream to its original uncompressed state. The MCTF decoder 230 converts the uncompressed macroblock information stream and the uncompressed motion vector stream back to an original video signal according to an MCTF scheme.

MCTF decoder 230 includes, as an internal element, an inverse filter as shown in FIG. 6 for restoring an input stream to its original frame sequence.

The inverse filter of FIG. 6 includes a front processor 231, an inverse updater 232, an inverse predictor 233, an arranger 234, and a motion vector analyzer 235. The front processor 231 divides an input stream into H frames and L frames, and analyzes information in each header in the stream. The inverse updater 232 subtracts pixel difference values of input H frames from corresponding pixel values of input L frames. The inverse predictor 233 restores input H frames to frames having original images using the H frames and the L frames from which the image differences of the H frames have been subtracted. The arranger 234 interleaves the frames, completed by the inverse predictor 233, between the L frames output from the inverse updater 232, thereby producing a normal video frame sequence. The motion vector analyzer 235 decodes an input motion vector stream into motion vector information of each block and provides the motion vector information to the inverse updater 232 and the inverse predictor 233. Although one inverse updater 232 and one inverse predictor 233 are illustrated above, a plurality of inverse updaters 232 and a plurality of inverse predictors 233 are provided upstream of the arranger 234 in multiple stages corresponding to the MCTF encoding levels described above.

The front processor 231 analyzes and divides an input stream into an L frame sequence and an H frame sequence. In addition, the front processor 231 uses information in each header in the stream to notify the inverse updater 232 and the inverse predictor 233 of which frame or frames have been used to produce macroblocks in the H frame.

Particularly, the front processor 231 confirms a ‘disable_filtering’ information field included in a header area of a GOP in the stream or a header area of a slice layer in the GOP. If the confirmed ‘disable_filtering’ information field is deactivated, the front processor 231 provides information, which indicates that there is a need to perform a filtering operation on reference blocks, to the inverse estimator 233. If the confirmed ‘disable_filtering’ information field is activated, the front processor 231 provides information, which prevents the filtering operation, to the inverse predictor 233.

The inverse updater 232 performs the operation of subtracting an image difference of an input H frame from an input L frame in the following manner. For each macroblock in the input H frame, the inverse updater 232 confirms a reference block present in an L frame prior to or subsequent to the H frame or two reference blocks present in two L frames prior to and subsequent to the H frame, using a motion vector provided from the motion vector analyzer 235, and performs the operation of subtracting pixel difference values of the macroblock of the input H frame from pixel values of the confirmed one or two reference blocks.

The inverse predictor 233 may restore an original image of each macroblock of the input H frame by selectively performing the filtering operation on the reference block, from which the image difference of the macroblock has been subtracted in the inverse updater 232, based on the ‘disable_filtering’ information received from the front processor 231; and then adding the pixel values of the selectively filtered (i.e., filtered or unfiltered) reference block to the pixel difference values of the macroblock.

If the macroblocks of an H frame are restored to their original images by performing the inverse update and prediction operations on the H frame in specific units (for example, in units of frames or slices) in parallel, the restored macroblocks are combined into a single complete video frame.

The above decoding method restores an MCTF-encoded data stream to a complete video frame sequence. In the case where the estimation/prediction and update operations have been performed for a video frame interval N times (N levels) in the MCTF encoding procedure described above, a video frame sequence with the original image quality is obtained if the inverse estimation/prediction and update operations are performed N times in the MCTF decoding procedure. However, a video frame sequence with a lower image quality and at a lower bitrate is obtained if the inverse estimation/prediction and update operations are performed less than N times. Accordingly, the decoding device is designed to perform inverse estimation/prediction and update operations to the extent suitable for its performance.

The decoding device described above may be incorporated into a mobile communication terminal or the like or into a media player.

As is apparent from the above description, when a video signal is encoded/decoded according to an embodiment of the present invention, the video signal is selectively filtered at a prediction step and at an inverse prediction step; thereby improving encoding/decoding performance and increasing coding gain.

Although the example embodiments of the present invention have been disclosed for illustrative purposes, those skilled in the art will appreciate that various modifications, additions and substitutions are possible, without departing from the scope and spirit of the invention.

1. A method of decoding an encoded video signal by inverse motion compensated temporal filtering (MCTF), comprising:
selectively filtering at least one reference block from the encoded video signal;
decoding at least one target block in the encoded video signal based on the selectively filtered reference block.

2. The method of claim 1, wherein the decoding step comprises:
adding the target block and selectively filtered reference block.

3. The method of claim 1, further comprising:
subtracting the target block from an encoded reference block to obtain the reference block.

4. The method of claim 3, further comprising:
searching for the encoded reference block of the target block in at least one of the frames neighboring a frame including the target block.

5. The method of claim 1, further comprising:
obtaining information from the encoded video signal indicating whether the reference block was filtered during encoding; and wherein
the selectively filtering step selectively filters the reference block based on the obtained information.

6. The method according to claim 5, wherein the selectively filtering step does not filter the reference block if the information is deactivated, and filters the reference block if the information is activated.

7. The method according to claim 5, wherein the information indicating whether or not the reference block has been filtered is set in units of frame groups.

8. The method according to claim 5, wherein the information indicates whether or not reference blocks for target blocks in a group of frames have been filtered.

9. The method according to claim 8, wherein obtaining step obtains the information from a header area of the group of frames.

10. The method according to claim 5, wherein the information indicates whether or not the reference block has been filtered is set in units of slices in a group of frames.

11. The method according to claim 5, wherein the information indicates whether or not reference blocks for target blocks in a slice have been filtered.

12. The method according to claim 11, wherein the obtaining step obtains the information from a header area of the slice.

13. A method of encoding a video signal by motion compensated temporal filtering (MCTF), comprising:
selectively filtering at least one reference block obtained from the video signal;
encoding at least one target block in the video signal based on the selectively filtered reference block.

14. The method of claim 13, wherein the selectively filtering step selectively filters the reference block based on a control signal.

15. The method of claim 13, wherein the selectively filtering step does not filter the reference block if the target block represents a portion of an image having high resolution and low motion with respect to the image represented at least in part by the reference block.

16. The method of claim 13, further comprising:
adding information to the encoded video signal indicating whether the reference block was filtered.

17. A method of encoding a video signal by motion compensated temporal filtering (MCTF), comprising:
adding information to the encoded video signal indicating whether a reference block, used in encoding the encoded video signal, has been filtered.
